(19) United States
(12) Patent Application Publication
(10) Pub. No.: US 2014/0072048 A1
(43) Pub. Date: Mar. 13, 2014

(54) METHOD AND APPARATUS FOR A SWITCHABLE DE-RINGING FILTER FOR IMAGE/VIDEO CODING

(71) Applicant: Samsung Electronics Co., LTD, Suwon-si (KR)

(72) Inventors: Qirong Ma, Seattle, WA (US); Wang Lin Lai, San Jose, CA (US); Zhan Ma, San Jose, CA (US); Felix C. A. Fernandes, Plano, TX (US)

(73) Assignee: Samsung Electronics Co., LTD, Suwon-si (KR)

(21) Appl. No.: 14/017,156

(22) Filed: Sep. 3, 2013

Related U.S. Application Data
(60) Provisional application No. 61/700,766, filed on Sep. 13, 2012.

(51) Int. Cl. H04N 7/34

(52) U.S. Cl. CPC H04N 19/00763
USPC 375/240.16

(57) ABSTRACT

Apparatus and methods are provided to process a downsampled image. The downsampled image is encoded. The downsampled image is upsampled. The downsampled image is filtered in combination with the upsampling to form predictor image. Weights of a spatial weight matrix are based on a spatial scaling ratio.

### CROSS-REFERENCE TO RELATED APPLICATION(S) AND CLAIM OF PRIORITY

The present application claims priority to U.S. Provisional Patent Application Ser. No. 61/700,766, filed Sep. 13, 2012, entitled “SWITCHABLE DE-RINGING FILTER FOR IMAGE/VIDEO CODING”. The content of the above-identified patent document is incorporated herein by reference.

### TECHNICAL HELD

The present application relates generally to scalable video coding and, more specifically, to a de-ringing filter used with scalable video coding.

### BACKGROUND

Networked video is becoming a more important part in our daily life. Individuals can easily enjoy the TV show, movies through wired or wireless connections. Alternatively, there are thousands devices, which are with quite different processing capability (i.e., CPU speed, network bandwidth, et cetera), for video content presentation.

### SUMMARY

A method of an electronic device for processing a downsampled image is provided. The method includes encoding the downsampled image. The method also includes upsampling the downsampled image. The method also includes filtering the downsampled image in combination with the upsampling to form a predictor image. Weights of a spatial weight matrix are based on a spatial scaling ratio.

An apparatus configured to process a downsampled image is provided. The apparatus comprises a memory configured to store the downsampled image. The apparatus further comprises one or more processors configured to encode the downsampled image. The one or more processors are further configured to upsample the downsampled image. The one or more processors are further configured to filter the downsampled image in combination with the upsampling to form a predictor image. Weights of a spatial weight matrix are based on a spatial scaling ratio.

A computer readable medium is provided. The computer readable medium comprises one or more programs for processing an image, the one or more programs comprising instructions that, when executed by one or more processors, cause the one or more processors to encode the downsampled image. The instructions further cause the one or more processors to upsample the downsampled image. The instructions further cause the one or more processors to filter the downsampled image in combination with the upsampling to form a predictor image. Weights of a spatial weight matrix are based on a spatial scaling ratio.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates scalable video delivery over a heterogeneous network to diverse clients according to embodiments of the present disclosure;

FIG. 2 illustrates two-layer spatial scalable video coding according to embodiments of the present disclosure;

FIGS. 3A-3B illustrate images that have been upsampled from a base layer prior to using a de-ringing filter according to embodiments of the present disclosure;

FIGS. 3C-3D illustrate the original images prior to downsampling according to embodiments of the present disclosure;

FIG. 4A illustrates DCT based 2× upsampling in accordance with embodiments of the present disclosure;

FIG. 4B illustrates DCT based 2× upsampling with de-ringing filtering in accordance with embodiments of the present disclosure;

FIG. 5 illustrates upsampling an image from a base layer and applying a de-ringing filter after the upsampling in accordance with embodiments of the present disclosure;

FIG. 6 illustrates applying a de-ringing filter to an image in accordance with embodiments of the present disclosure;

FIGS. 7A-7B illustrate images that have been upsampled from a base layer prior to using a de-ringing filter according to embodiments of the present disclosure;

FIGS. 7C-7D illustrate the original images prior to downsampling according to embodiments of the present disclosure;

FIGS. 7E-7F illustrate images created from a base layer and an enhancement layer according to embodiments of the present disclosure;

FIG. 8 illustrates a coding unit level rate-distortion optimized switchable de-ringing filter according to embodiments of the present disclosure; and

FIG. 9 illustrates an electronic device according to embodiments of the present disclosure.

### DETAILED DESCRIPTION

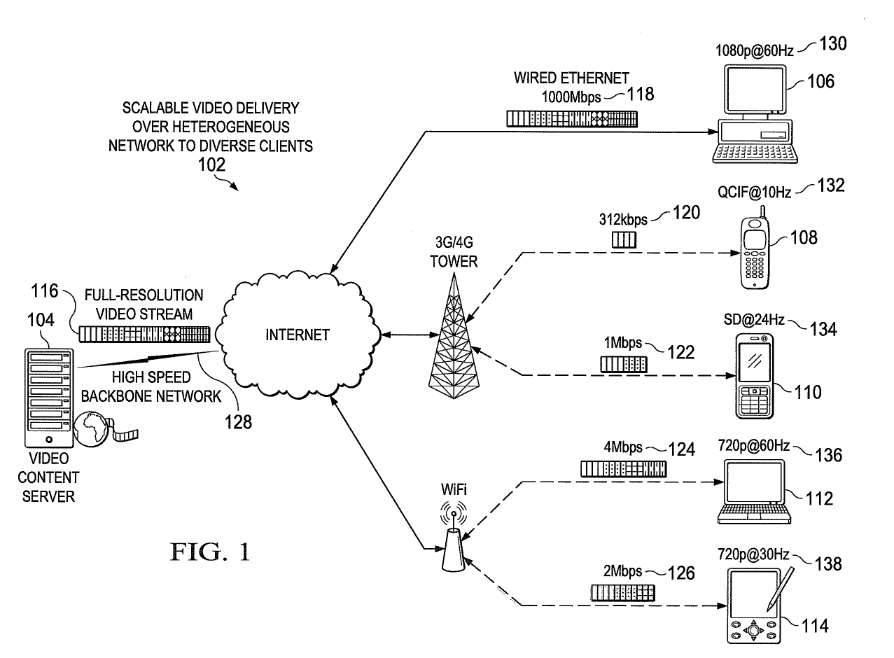

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

It is highly desirable to have one efficient video coding technology, that can provide the sufficient compression performance and also be friendly to the heterogeneous underlying networks and subscribed clients. Transcoding is one solution for such purpose. However, transcoding normally introduces a huge computing workload for real-time processing, especially for multi-user cases. Alternatively, scalable video coding (SVC) is a decent solution, where a full resolution video bitstream can be truncated/adapted at the network gateway or edge server to connected devices. Compared with the computational intensive transcoding, SVC adaptation is extremely lightweight.

FIG. 1 illustrates scalable video delivery over a heterogeneous network to diverse clients according to embodiments of the present disclosure. The embodiment shown in FIG. 1 is for illustration only. Other embodiments could be used without departing, from the scope of this disclosure.

A heterogeneous network 102 includes a video content server 104 and clients 106-114. The video content server 104 sends full resolution video stream 116 via heterogeneous network 102 to be received by clients 106-114. Clients 106-114 receive some or all of full resolution video stream 116 at via one or more bit rates 118-126 and one or more resolutions 130-138 based on a type of connection to heterogeneous network 102 and a type of client. The types and bit rates of connections to heterogeneous network 102 include high speed backbone network connection 128, 1000 megabit per second (Mbps) connection 118, 312 kilobit per second (kbps) connection 120, 1 Mbps connection 122, 4 Mbps connection 124, 2 Mbps connection 126, and so forth. The one or more resolutions 130-138 include 1080 progressive (1080 p) at 60 Hertz (1080 p @ 60 Hz) 130, quarter common intermediate format (QCIF) @ 10 Hz 132, standard definition (SD) @ 24 Hz 134, 720 progressive (720 p) @ 60 Hz 136, 720 p @ 30 Hz 138, et cetera. Types of clients 106-114 include desktop computer 106, mobile phone 108, personal digital assistant (PDA) 110, laptop 112, tablet 114, et cetera.

Recently, the Joint collaborative team on video coding (JCT-VC) has issued the call-for-proposal (CfP) for scalability extension standardization to develop the high-efficiency scalable coding technology. To widely facilitate industry requirements, there are several scalability categories, such as H.264/advanced video coding (AVC) compliant base layer and high-efficiency video coding (HEVC) standard compliant enhancement layer, both HEVC compliant base and enhancement layer, et cetera. Embodiments of the present disclosure use HEVC compliant base and enhancement layers, but the teachings are applicable to other scalability categories and combinations of base and enhancement layers, such as H.264/AVC or MPEG-2 compliant base layer with HEVC compliant enhancement layer.

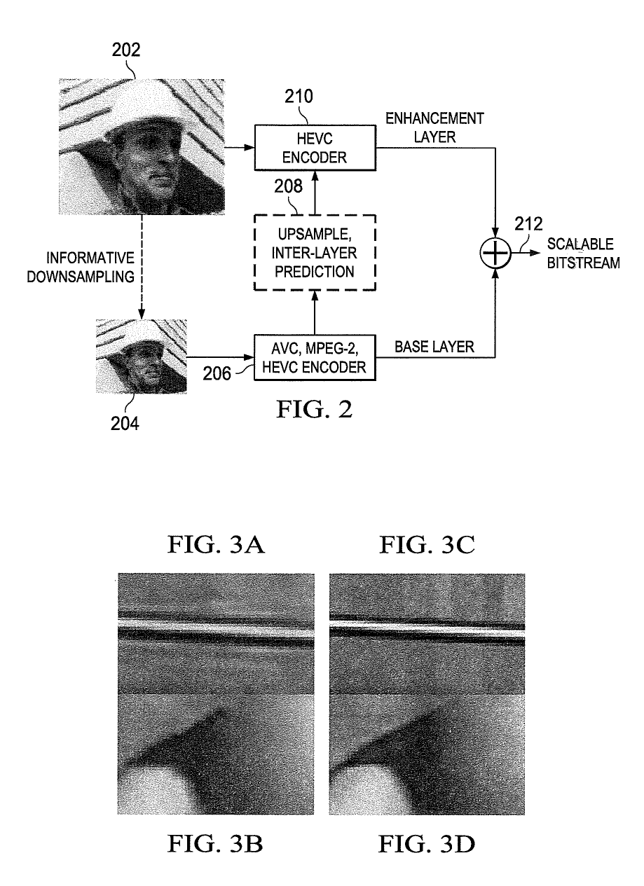

FIG. 2 illustrates two-layer spatial scalable video coding according to embodiments of the present disclosure. The embodiment shown in FIG. 2 is for illustration only. Other embodiments could be used without departing from the scope of this disclosure.

Images, such as image 202, of a bitstream are downsampled to form downsampled images, such as image 204. The encoder 206 generates a base layer of a video bitstream using downsampled images. The encoder 210 generates an enhancement layer of a video bitstream using the base layer generated by encoder 206 and inter-layer prediction 208. The enhancement layer is created by upsampling the base layer from encoder 206 applying interlayer prediction 208 and comparing upsampled predicted images with original images, such as image 202. Differences between the upsampled predicted base layer and the original images are encoded by encoder 210 to create the enhancement layer. The base layer and the enhancement layer are combined to form scalable bitstream 212 distributed by a heterogeneous network, such as heterogeneous network 102.

FIGS. 3A-3B illustrate images that have been upsampled from a base layer prior to using a de-ringing filter according to embodiments of the present disclosure. FIGS. 3C-3D illustrate the original images prior to downsampling according to embodiments of the present disclosure. The embodiments shown in FIGS. 3A-3D are for illustration only. Other embodiments could be used without departing from the scope of this disclosure.

For a scalable coder, reconstructed pictures from the base layer are upsampled to serve as the predictor for enhancement layer encoding. Any of a number of up-sampling filters are used, including bi-linear filters, and Wiener filters, as well as recent discrete cosine transform (DCT) based solutions. Bi-linear and Wiener upsampling filters use fixed coefficients, which do not reflect local content variations. DCT based upsampling introduces noticeable ringing artifacts in upsampled base layer reconstructed signals, as shown in comparing the images of FIGS. 3A-3B with FIGS. 3C-3D. Such artifacts will hurt the coding efficiency for the enhancement layer encoding. The de-ringing filter reduces these artifacts and improves the coding efficiency.

Bilateral filters can be used to do the filtering so as to reduce the noise and enhance the image edge. However, a bilateral filter typically requires significant computing power because of its complicated processing, as compared to the de-ringing filter.

Embodiments of the present disclosure describe the switchable de-ringing filter (SDRF) for scalable video coding (SVC). More specifically, an SDRF is utilized to improve the inter-layer prediction for SVC, so as to improve the overall coding efficiency. As described, the SDRF is implemented on top of HEVC scalability software. The SDRF demonstrates a noticeable coding efficiency improvement. SDRF is not limited to the current implementation. SDRF is applicable to any type of the scalable coder to improve the reconstructed base layer so as to benefit the overall coding performance. The teachings of the present disclosure are applicable to any image/video coder to improve the performance, reduce the noise and enhance the image/video quality.

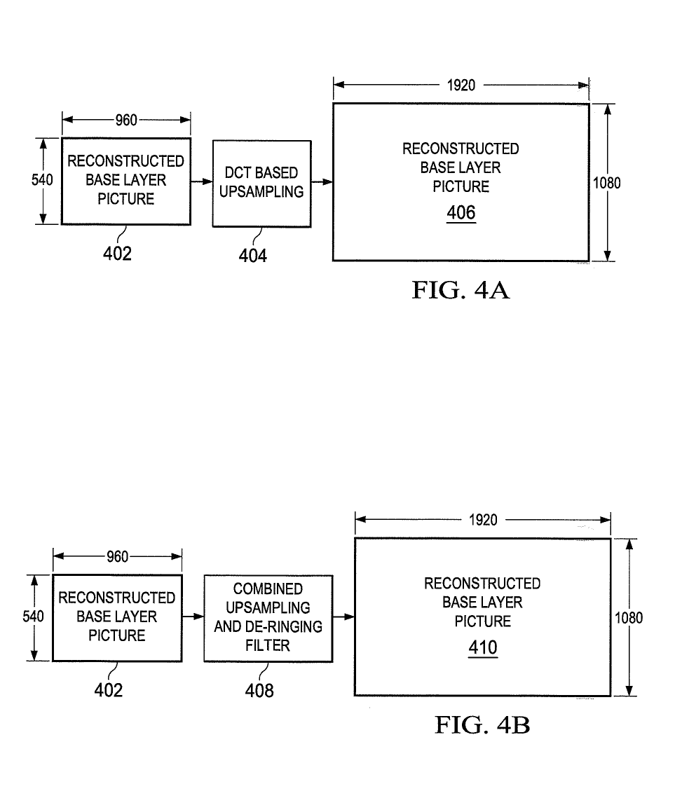

FIG. 4A illustrates DCT based 2× upsampling in accordance with embodiments of the present disclosure. FIG. 4B illustrates DCT based 2× upsampling with de-ringing filtering in accordance with embodiments of the present disclosure. The embodiments shown in FIGS. 4A-4B are for illustration only. Other embodiments could be used without departing from the scope of this disclosure.

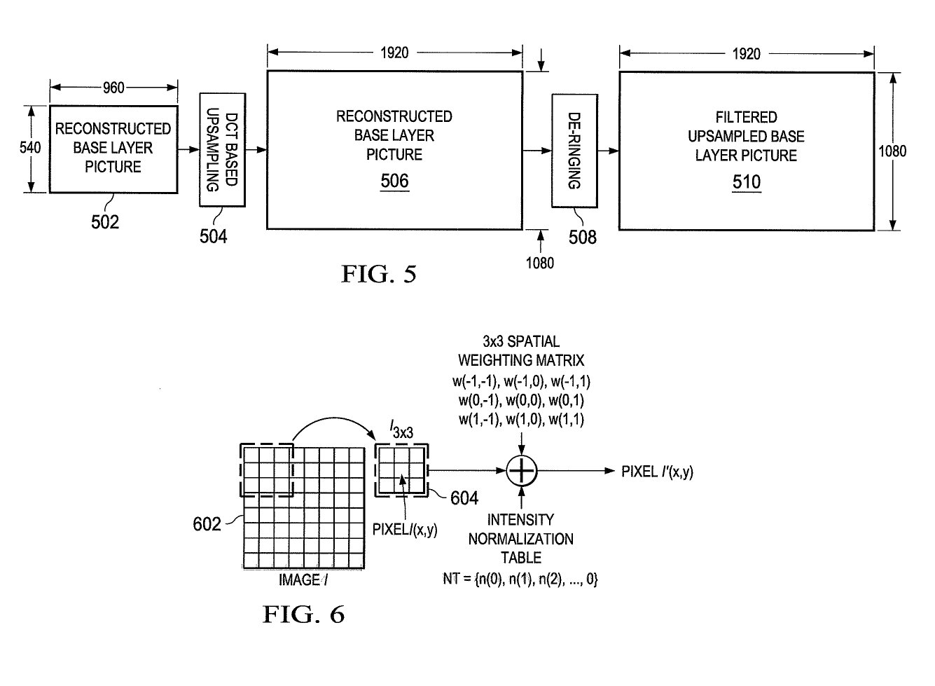

Downsampling followed by upsampling introduces noticeable ringing artifacts and hurts coding efficiency. The de-ringing filter operations disclosed are applied in conjunction with upsampling to remove ringing artifacts, reduce the noise and improve the coding efficiency. The filter and the upsampling are linear operations, the filter can be applied as a part of the upsampling, as in FIG. 4B, and can be applied after the upsampling, as in FIG. 5.

Image 402 is a downsampled image reconstructed from a base layer. Upsampler 404 upsamples image 402 to form upsampled image 406. Upsampler 408 upsamples image 402 to form upsampled image 410. Image 402 has a resolution of 960 by 540 pixels and image 406 has a resolution of 1920 by 1080 pixels. Upsampler 408 includes a de-ringing filter to form image 410. Image 410 is a predictor image used to predict a final displayed image.

FIG. 5 illustrates upsampling an image from a base layer and applying a de-ringing filter after the upsampling in accordance with embodiments of the present disclosure. The embodiment shown in FIG. 5 is for illustration only. Other embodiments could be used without departing from the scope of this disclosure.

Image 502 is a downsampled image that is reconstructed from a base layer. Image 502 is upsampled by upsampler 504 to form upsampled image 506. Image 506 is filtered in combination with the upsampling by de-ringing filter 508 to form image 510. Image 510 is a predictor image used to predict a final displayed image. Image 502 has a resolution of 960 by 540 pixels and images 506 and 508 each have a resolution of 1920 by 1080 pixels.

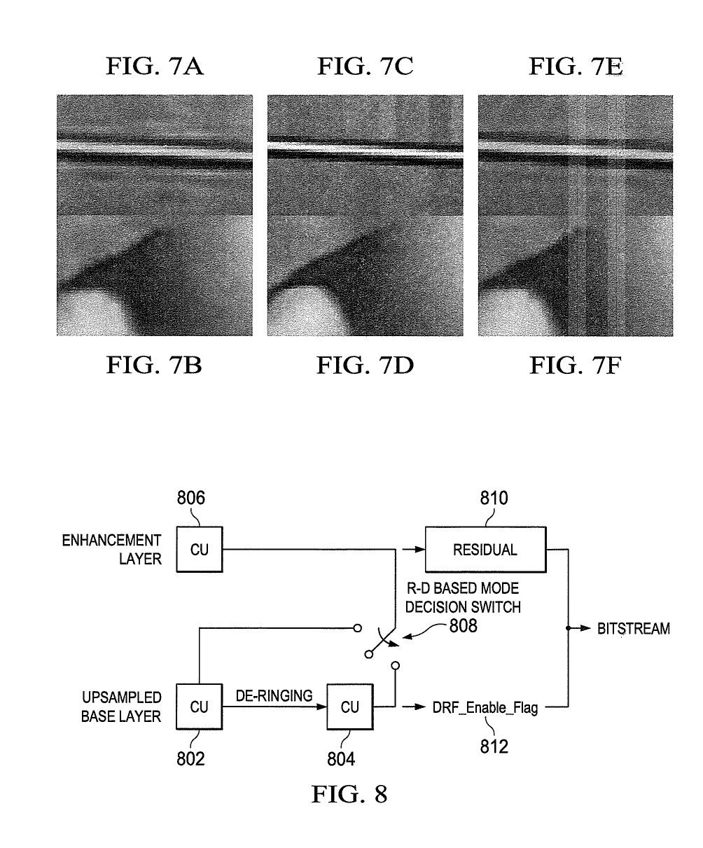

As shown in FIG. 5, de-ringing filter 508 is applied on upsampled base layer signal that removes ringing artifacts and suppress noise, such as artifacts and noise seen in FIGS. 3A-3B and FIGS. 7A-7B. De-ringing filter 508 is performed on an N×N block basis, for both luminance (noted as luma) and chrominance (noted as chroma) components of an image.

FIG. 6 illustrates applying a de-ringing filter to an image in accordance with embodiments of the present disclosure. The embodiment shown in FIG. 6 is for illustration only. Other embodiments could be used without departing from the scope of this disclosure.

Described is the use of a 3×3 block basis, but any block size may be used. For example, certain embodiments can use a one-dimensional, separable filter of the form N×1. The one-dimensional filter is first applied along rows and then along columns (or first along columns and then along rows).

The filter is a bilateral filter. A symmetric spatial weighting matrix (w) is defined:

$$w = [ \begin{matrix}a & b & a \\ b & c & b \\ a & b & a\end{matrix} ] \qquad ( 1 )$$

where a, b, and c are integers and the weights a, b, and c of spatial weighting matrix are based on a spatial scaling ratio (e.g., 2× or 1.5×). An intensity normalization table (NT) is defined:

NT={n(0),n(1),n(N),0} (2)

where n(0), n(1), . . . , and n(N) follow a Gaussian or Exponential distribution. Certain embodiments of the present disclosure have one of the weights of the spatial weight matrix and the values of NT comprise a highest value of less than 9 in certain embodiments and less than 65 in certain embodiments. As shown in FIG. 6, for any 3×3 pixel block, such as block 604, in a frame I, such as image 602, using the middle pixel position as (x, y) yields the pixel domain 3×3 block as

$${I}_{3 \times 3} = [ \begin{matrix}I ( x - 1 , y - 1 ) & I ( x , y - 1 ) & I ( x + 1 , y - 1 ) \\ I ( x - 1 , y ) & I ( x , y ) & I ( x + 1 , y ) \\ I ( x - 1 , y + 1 ) & I ( x , y + 1 ) & I ( x + 1 , y + 1 )\end{matrix} ] . \qquad ( 3 )$$

Also defined is a neighboring pixel difference index that indexes. NT via quantized pixel-intensity differences. This index uses gs, a granularity shift index, to control the normalization granularity, i.e.,

idx(i,j)=(abs(I(x,y)−I(x−i,y−j)+1<<(gs−1))>>gs,i,jε{−1,0,1}, (4)

with abs( ) as the absolute function, gs as the granularity shift index which is used to control the normalization granularity, the “<<” operator being a binary shift left, and the “>>” operator being a binary shift right. In certain embodiments, gs is set to 0 so that the index idx(i,j), is simply the absolute value of the difference between the pixel intensities I(x,y) and I(x−i, y−j).

A filtered pixel at the (x,y)-th position, i.e., I′(x, y), is derived as:

$$den = {\sum }_{i , j ∈ \{ - 1 , 0 , 1 \}} w ( i + 1 , j + 1 ) \cdot N T ( idx ( i , j ) ) , \\ sum = {\sum }_{i , j ∈ \{ - 1 , 0 , 1 \}} {I}_{3 \times 3} ( x - i , y - j ) \cdot w ( i + 1 , j + 1 ) \cdot NT ( idx ( i , j ) ) , \\ {I}^{′} ( x , y ) = ( sum + ( den ≫ 1 ) ) / den . \qquad ( 5 )$$

For certain embodiments using a Gaussian function to design the filter,

$$w = [ \begin{matrix}1 & 2 & 1 \\ 2 & 4 & 2 \\ 1 & 2 & 1\end{matrix} ]$$

for both luma and chroma with 2× spatial scalability and

$$w = [ \begin{matrix}1 & 2 & 1 \\ 2 & 12 & 2 \\ 1 & 2 & 1\end{matrix} ]$$

for both luma and chroma with 1.5× spatial scalability, with NT={8, 4, 2, 1, 0} and gs=3, for both 2× and 1.5× spatial scalability.

For certain embodiments,

$$w = [ \begin{matrix}1 & 4 & 1 \\ 4 & 12 & 4 \\ 1 & 4 & 1\end{matrix} ]$$

for both luma and chroma with 2× spatial scalability and

$$w = [ \begin{matrix}3 & 4 & 3 \\ 4 & 5 & 4 \\ 3 & 4 & 3\end{matrix} ]$$

for both luma and chroma with 1.5× spatial scalability, with NT={64, 61, 54, 44, 33, 23, 15, 9, 5, 2, 1, 0} and gs=2 for both 2× and 1.5× spatial scalability.

The Gaussian and/or exponential kernels listed above are examples. Other filter kernels, for example with increased/decreased decay of exponential kernel coefficients, or with a varied variance of the Gaussian kernel coefficients, can be easily constructed using the teachings of the present disclosure.

FIGS. 7A-7B illustrate images that have been upsampled from a base layer prior to using a de-ringing filter according to embodiments of the present disclosure. FIGS. 7C-7D illustrate the original images prior to downsampling according to embodiments of the present disclosure. FIGS. 7E-7F illustrate images created from a base layer and an enhancement layer according to embodiments of the present disclosure. The embodiments shown in FIGS. 7A-7F are for illustration only. Other embodiments could be used without departing from the scope of this disclosure.

As shown in FIGS. 7E-7F, a de-ringing filter can enhance image edges, remove ringing artifacts, and reduce noise. Compared with pure DCT based upsampling (shown in FIGS. 7A-7B), de-ringing filtered upsampled base layer can improve the scalable enhancement layer encoding by about 0.6% and 1.0% Bjontegaard delta rate (BD-RATE) decrease for All intra (AI) and random access (RA) test conditions defined for 2× spatial scalability, and by about 0.1% and 0.2% BD-RATE decrease for AI and RA of 1.5× spatial scalability.

Compared with a bilateral filter, embodiments of the present disclosure significantly reduce complexity. In particular, these embodiments use small 3×3 masks which are comprised of multipliers 1, 2, 3, 4, 5 and 12, which are also referred to as spatial weights, that are implementable in hardware with at most 2 shifters and 1 adder. In certain embodiments, the spatial weights are implemented via substantially few adders and shifters, wherein substantially few comprises one or more of 4 or less, 8 or less, and 12 or less. More complex embodiments can use more adders and shifters as compared to less complex embodiments while still using substantially few adders and shifters. Such low-complexity implementations are highly valued for practical commercial implementations and for standardization. Alternatively, in addition to Gaussian function, an exponential function also can be applied to design the filter.

In certain embodiments an exponential function is utilized to design the filter,

$$w = [ \begin{matrix}1 & 2 & 1 \\ 2 & 4 & 2 \\ 1 & 2 & 1\end{matrix} ]$$

for both luma and chroma with 2× spatial scalability and

$$w = [ \begin{matrix}1 & 2 & 1 \\ 2 & 12 & 2 \\ 1 & 2 & 1\end{matrix} ]$$

for both luma and chroma with 1.5× spatial scalability, with NT={8, 4, 2, 1, 0}, and gs=3, for both 2× and 1.5× spatial scalability.

Certain embodiments include

$$w = [ \begin{matrix}1 & 4 & 1 \\ 4 & 12 & 4 \\ 1 & 4 & 1\end{matrix} ]$$

for both luma and chroma with 2× spatial scalability,

$$w = [ \begin{matrix}3 & 4 & 3 \\ 4 & 5 & 4 \\ 3 & 4 & 3\end{matrix} ]$$

for both luma and chroma with 1.5× spatial scalability, and NT={64, 61, 54, 44, 33, 23, 15, 9, 5, 2, 1, 0}, gs=2 for both 2× and 1.5× spatial scalability.

The Gaussian and/or exponential kernels listed above are examples. Other filter kernels, with increased/decreased decay of exponential kernel coefficients, or with varied variance of the Gaussian kernel coefficients, can be easily constructed using the teachings of the present disclosure. In certain embodiments, the filter w, table NT and parameter gs are indexed by the quantization parameter that was used by encoder 206 (in FIG. 2) to encode the block that is being filtered. In such embodiments, the de-ringing filter adapts to the quantization level of each block that is filtered.

As shown in FIGS. 7E-7F, a de-ringing filter can enhance the image edge, remove the ringing artifacts and reduce the noise as compared to FIGS. 7A-7B. FIGS. 7E-7F are a closer approximation of original images so that less information will need to be coded in an enhancement layer used to create images of FIGS. 7C-7D.

Compared with pure DCT based upsampling, de-ringing filtered upsampled base layer can improve scalable enhancement layer encoding by about 0.6% and 1.0% BD-RATE decrease for All intra (AI) and random access (RA) test conditions defined for 2× spatial scalability, and by about 0.1% and 0.2% BD-RATE decrease for AI and RA of 1.5× spatial scalability.

Compared with a bilateral filter, the teachings of the present disclosure significantly reduce complexity, which is favored in practical commercial implementations and in standardization.

FIG. 8 illustrates a coding unit level rate-distortion optimized switchable de-ringing filter according to embodiments of the present disclosure. The embodiment shown in FIG. 8 is for illustration only. Other embodiments could be used without departing from the scope of this disclosure.

The rate-distortion based mode switch 808 selects one of CUs 802 or 804 to predict CU 806 and thus create residual 810. CU 802 is created from a base layer prior to a de-ringing filter being applied. CU 804 is created from a base layer after a de-ringing filter is applied. CU 806 is from an enhancement layer The DRF_Enable_Flag 812 is included in the bitstream along with the residual. This flag signals whether 802 or 804 was used to create Residual 810.

Ringing artifacts often happen in edge areas of images, i.e., areas where there is a substantial change in color, contrast, brightness, hue, intensity, saturation, luma, chroma, et cetera. The ringing artifacts are due to the non-optimal nature of the downsampling and upsampling filters. For a stationary area without edges, the DCT based upsampling might provide better coding efficiency. A switchable de-ringing filter advantageously switches between using a de-ringing filter and not using the de-ringing filter. The switching decision can be made at the coding unit (CU) level, or at the largest CU (LCU) level, via either rate-distortion, sum-of-the-absolute-difference (SAD), or other criteria. Here, it can be seen that LCU based switchable de-ringing filter is one example of the recursive CU based solution. A CU is a block of pixels and an LCU is a largest block of pixels used by an encoder or decoder.

For each CU encoded in an enhancement layer, the following coding modes are defined:

a. Intra-layer intra prediction (normal spatial domain prediction);

b. Intra-layer inter prediction (normal temporal prediction);

c. Inter-layer intra prediction (using upsampled base layer as predictor); and

d. Inter-layer inter prediction (using base layer motion information).

Whether to use a DCT upsampled base layer signal or a filtered upsampled signal is based on the rate-distortion cost for each mode selection. A de-ringing enable flag (e.g., DRF_Enable_Flag) is also defined to indicate to a decoder whether the base layer signal is only DCT upsampled or requires de-ringing filtering. The flag can be implemented using either content-adaptive binary arithmetic codes (CABAC) or content-adaptive variable length codes (CAVLC). For CABAC coded flag, the flag is interleaved into the CU level, and for CAVLC coded flag, the flag is put in a slice header of an application parameter set (APS). The de-ringing filtering process is the same as described with respect to FIGS. 2-7.

If DRF_Enable_Flag==1 (or TRUE), a decoder filters, via a de-ringing filter, the upsampled base layer CU block as a predictor of a final image. If DRF_Enable_Flag==0 (or FALSE), the decoder uses the DCT upsampled CU block as the predictor without utilizing the de-ringing filter. The DRF_Enable_Flag is associated with each coding unit used to form the predictor image and indicates whether filtering is applied to a respective coding unit.

In addition to CU level processing, switchable de-ringing filter can be realized in a LCU level as well. For encoder complexity reduction, instead of using rate-distortion criteria, the SAD based decision can be used as well. As shown in FIG. 8, if a SAD based decision is used, for each LCU, its SAD is derived between upsampled base layer signal and original enhancement layer signal, then choose the one which yields less distortion. Other decision criteria can also be used without departing from the scope of this disclosure.

Certain embodiments realize the de-ringing filter at a block level. Certain embodiments introduce the DRF_Enable_Flag into the video coding standards and the flag is realized using either CABAC or CAVLC.

Certain embodiments do not use the DRF_Enable_Flag by applying the classification or edge detection technology. For example, edge blocks within an image or picture can be classified for every base layer picture, so that a de-ringing filter is applied to the edge blocks. When a block does not contain an edge, the original DCT based upsampling is used. Since the classification can be done the same way by an encoder and a decoder using reconstructed base layer, a flag, such as the DRF_Enable_Flag does not need to be transmitted. Not using the flag reduces the number of bits needed for coding a block and further improves coding efficiency.

In certain embodiments, a division operation of the filtering process is realized or implemented via a look-up table. The look-up table can be derived for possible values of 1/den that are multiplied by (sum+(den>>1)) to find I′(x, y).

For classification-based bit hiding or filter switching, machine learning technology can be used to derive a rate distortion (R−D) optimal predictor (i.e., either DCT upsampled signal or de-ringing filtered upsampled signal) with image features. These features are derived from the image statistics that are used by a machine learning algorithm and serve as the predictor selection criteria.

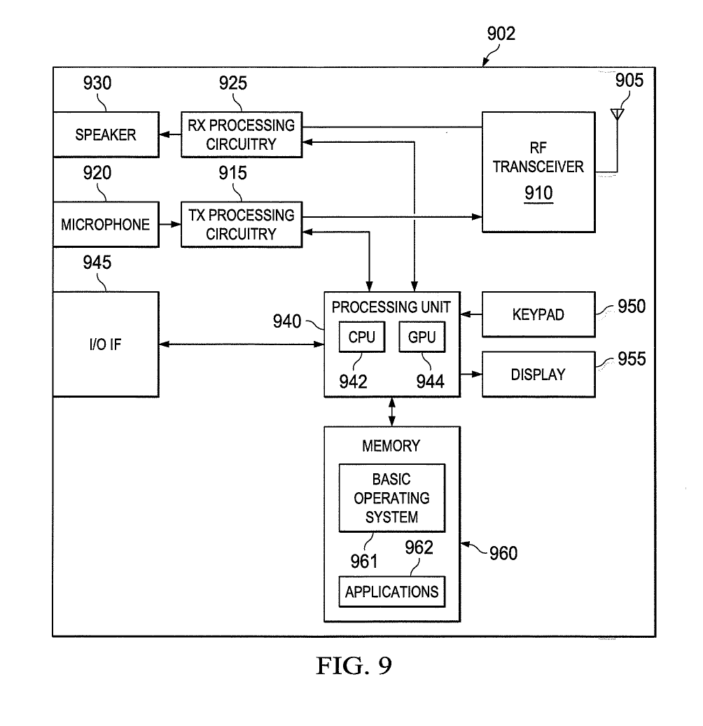

FIG. 9 illustrates an electronic device according to embodiments of the present disclosure. The embodiment of an electronic device shown in FIG. 9 is for illustration only. Other embodiments of the MS could be used without departing from the scope of this disclosure.

Electronic device 902 and comprises one or more of antenna 905, radio, frequency (RF) transceiver 910, transmit (TX) processing circuitry 915, microphone 920, and receive (RX) processing circuitry 925. Electronic device 902 also comprises one or more of speaker 930, processing unit 940, input/output (I/O) interface (IF) 945, keypad 950, display 955, and memory 960. Processing unit 940 includes processing circuitry configured to execute a plurality of instructions stored either in memory 960 or internally within processing unit 940. Memory 960 further comprises basic operating system (OS) program 961 and a plurality of applications 962. Electronic device 902 is an embodiment of server 104 and clients 106-114 of FIG. 1.

Radio frequency (RF) transceiver 910 receives from antenna 905 an incoming RF signal transmitted by a base station of wireless network 900. Radio frequency (RF) transceiver 910 down-converts the incoming RF signal to produce an intermediate frequency (IF) or a baseband signal. The IF or baseband signal is sent to receiver (RX) processing circuitry 925 that produces a processed baseband signal by filtering, decoding, and/or digitizing the baseband or IF signal. Receiver (RX) processing circuitry 925 transmits the processed baseband signal to speaker 930 (i.e., voice data) or to processing unit 940 for further processing (e.g., web browsing).

Transmitter (TX) processing circuitry 915 receives analog or digital voice data from microphone 920 or other outgoing baseband data (e.g., web data, e-mail, interactive video game data) from processing unit 940. Transmitter (TX) processing circuitry 915 encodes, multiplexes, and/or digitizes the outgoing baseband data to produce a processed baseband or IF signal. Radio frequency (RF) transceiver 910 receives the outgoing processed baseband or IF signal from transmitter (TX) processing circuitry 915. Radio frequency (RF) transceiver 910 up-converts the baseband or IF signal to a radio frequency (RF) signal that is transmitted via antenna 905.

In certain embodiments, processing unit 940 comprises a central processing unit (CPU) 942 and a graphics processing unit (GPU) 944 embodied in one or more discrete devices. Memory 960 is coupled to processing unit 940. According to some embodiments of the present disclosure, part of memory 960 comprises a random access memory (RAM) and another part of memory 960 comprises a Flash memory, which acts as a read-only memory (ROM).

In certain embodiments, memory 960 is a computer readable medium that comprises program instructions to encode or decode a bitstream via a scalable video codec using a de-ringing filter. When the program instructions are executed by processing unit 940, the program instructions are configured to cause one or more of processing unit 940, CPU 942, and GPU 944 to execute various functions and programs in accordance with embodiments of the present disclosure. According to some embodiments of the present disclosure, CPU 942 and GPU 944 are comprised as one or more integrated circuits disposed on one or more printed circuit boards.

Processing unit 940 executes basic operating system (OS) program 961 stored in memory 960 in order to control the overall operation of wireless electronic device 902. In one such operation, processing unit 940 controls the reception of forward channel signals and the transmission of reverse channel signals by radio frequency (RF) transceiver 910, receiver (RX) processing circuitry 925, and transmitter (TX) processing circuitry 915, in accordance with well-known principles.

Processing unit 940 is capable of executing other processes and programs resident in memory 960, such as operations for encoding or decoding a bitstream via a scalable video codec using a de-ringing filter as described in embodiments of the present disclosure. Processing unit 940 can move data into or out of memory 960, as required by an executing process. In certain embodiments, the processing unit 940 is configured to execute a plurality of applications 962. Processing unit 940 can operate the plurality of applications 962 based on OS program 961 or in response to a signal received from a base station. Processing unit 940 is also coupled to I/O interface 945. I/O interface 945 provides electronic device 902 with the ability to connect to other devices such as laptop computers, handheld computers, and server computers. I/O interface 945 is the communication path between these accessories and processing unit 940.

Processing unit 940 is also optionally coupled to keypad 950 and display unit 955. An operator of electronic device 902 uses keypad 950 to enter data into electronic device 902. Display 955 may be a liquid crystal display capable of rendering text and/or at least limited graphics from web sites. Alternate embodiments may use other types of displays.

Embodiments of the present disclosure improve the coding efficiency for scalable video coding. Although described in exemplary embodiments, aspects of one or more embodiments can be combined with aspects from another embodiment without departing from the scope of this disclosure.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of an electronic device for processing a downsampled image, the method comprising:
encoding the downsampled image;
upsampling the downsampled image; and
filtering the downsampled image in combination with the upsampling to form a predictor image,
wherein weights of a spatial weight matrix are based on a spatial scaling ratio.

2. The method of claim 1, wherein a bilateral filter is used as a part of the filtering, the bilateral filter comprising exponentially distributed spatial weights.

3. The method of claim 1, wherein the spatial weights are implemented in hardware via substantially few adders and shifters.

4. The method of claim 1, wherein values of a spatial weighting matrix and a normalization table are used by the filtering and comprise a highest value of less than 65.

5. The method of claim 1, wherein a normalization table is indexed via quantized pixel-intensity differences and a granularity-shift index.

6. The method of claim 1, wherein the filtering comprises a division operation that is implemented via a look up table.

7. The method of claim 1, wherein a flag is associated with a coding unit used to form the predictor image, the flag indicates whether the filtering is applied to the coding unit.

8. The method of claim 1, wherein a determination for a coding unit used to form the predictor image is made based on values within the coding unit via one or more of edge classification and machine learning, the determination indicates whether the filtering is applied to the coding unit.

9. The method of claim 1, wherein the filtering is integrated with the upsampling.

10. The method of claim 1, wherein one-dimensional, separable filtering is used.

11. The method of claim 1, wherein the spatial-weighting matrix, normalization table and granularity-shift index are indexed by a quantization parameter.

12. An apparatus configured to process a downsampled image, the apparatus comprising:
a memory configured to store the downsampled image;
one or more processors configured to
encode the downsampled image;
upsample the downsampled image, and
filter the downsampled image in combination with the upsampling to form a predictor image,
wherein weights of a spatial weight matrix are based on a spatial scaling ratio.

13. The apparatus of claim 12, wherein a bilateral filter is used as a part of the filtering, the bilateral filter comprising exponentially distributed spatial weights.

14. The apparatus of claim 12, wherein the spatial weights are implemented in hardware via substantially few adders and shifters.

15. The apparatus of claim 12, wherein values of a spatial weighting matrix and a normalization table are used by the filtering and comprise a highest value of less than 65.

16. The apparatus of claim 12, wherein a normalization table is indexed via quantized pixel-intensity differences and a granularity-shift index.

17. The apparatus of claim 12, wherein the filtering comprises a division operation that is implemented via a look up table.

18. The apparatus of claim 12, wherein a flag is associated with a coding unit used to form the predictor image, the flag indicates whether the filtering is applied to the coding unit.

19. The apparatus of claim 12, wherein a determination for a coding unit used to form the predictor image is made based on values within the coding unit via one or more of edge classification and machine learning, the determination indicates whether the filtering is applied to the coding unit.

20. The apparatus of claim 12, wherein the filtering is integrated with the upsampling.

21. The apparatus of claim 12, wherein one-dimensional, separable filtering is used.

22. The apparatus of claim 12, wherein the spatial-weighting matrix, normalization table and granularity-shift index are indexed by a quantization parameter.
